(19) United States
(12) Patent Application Publication
(10) Pub. No.: US 2008/0288909 A1
(43) Pub. Date: Nov. 20, 2008

(54) Template-Based Domain-Specific Reconfigurable Logic

(75) Inventor: Katarzyna Leijten-Nowak, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,448

(22) PCT Filed: Dec. 7, 2004
(86) PCT No.: PCT/IB04/52684

§ 371 Date: Jun. 14, 2006

(30) Foreign Application Priority Data
Dec. 18, 2003 (EP) 03104791.3

(51) Int. Cl. G06F 17/50

(52) U.S. Cl. 716/16; 716/18

(57) ABSTRACT

A method is provided which creates an architecture of a reconfigurable logic core. The architecture can be deployed for various purposes and its implementation is costefficient in terms of area, performance and power. The invention relies on the perception that a template can be used to describe such an architecture. The architecture can then easily be created as an instance of the template. The template is a model which defines logic components, routing components and interface components of a reconfigurable logic core. For example, logic components may be logic elements, processing elements, logic blocks, logic tiles and arrays in a hierarchical order. Routing components may comprise routing channels comprising routing tracks which provide interconnection means between the logic components. Interface components may be input and output ports. The model is configured by a number of parameters; the value of these parameters is in accordance with an application domain.

The invention relates to a method for creating an architecture of a reconfigurable logic core on an integrated circuit, the architecture comprising logic components, routing components and interface components. The invention also relates to a reconfigurable logic core having an architecture created by such a method.

The ever continuing scaling of semiconductor technology has enabled ultra-scale integration. Therefore, a large number of today's IC's for consumer applications are implemented according to the system-on-chip concept. In a system-on-chip (SoC), system components (such as programmable cores, memories, coprocessors, peripherals) are integrated on the same piece of silicon. The on-chip integration improves performance of the system and reduces its cost.

Traditionally, the SoC components are implemented either as dedicated (hardwired) cores or as programmable (general-purpose or DSP) cores. The dedicated cores are characterized by high performance and the functionality is typically restricted to one specific function, whereas programmable cores are characterized by a relatively low performance and functionality which may be changed arbitrarily. Because of the dramatically growing IC mask set costs, the increasing importance of the cost versus performance aspect in emerging applications, and the competitive character of the consumer electronic market, designing SoCs using only dedicated and programmable cores does not provide a fully viable solution anymore.

For these reasons, reconfigurable logic is seen today as an attractive alternative to the dedicated and programmable cores. Firstly, reconfigurable logic allows for changes in device functionality after such a device is fabricated. Secondly, it offers a better-balanced trade-off between performance and cost than programmable processors do. Consequently, embedding reconfigurable logic in SoCs helps to reduce the number of costly redesigns of IC's and extends the lifetime of the final product.

A typical example of a reconfigurable logic device is an FPGA (Field Programmable Gate Array). An FPGA is an array of computing elements which are programmable to execute basic logic and arithmetic functions on the level of bits. The computing elements are surrounded by an interconnect network which is also programmable. The interconnect network enables communication between the computing elements. Programmable input/output elements which are placed at the outer edges of the array act as an interface with other system resources.

The programmable character of reconfigurable logic devices, though beneficial on the one hand because of their large application space, is also a reason for their area, performance, and power consumption overhead compared to dedicated-logic-based devices (ASICs). The overhead is caused by a large number of switches, configuration memory cells and interconnect wires which are present in such devices. Hence, the number of switches, configuration memory cells and interconnect wires must be balanced against the need for such components.

Because of various application areas and thus various system requirements, embedded FPGA (eFPGA) cores, which are fitted for integration on an SoC, must be available in different sizes and shapes. This is in contrast to stand-alone FPGAs that are usually produced in several predefined sizes and target the implementation of complete systems. Next to different sizes and shapes, eFPGA cores must also be cost-efficient in terms of area, performance and power, and they must be realizable in a relatively short time. These aspects are essential for designing high-quality SoCs for cost-sensitive consumer applications. The general-purpose architectures of today's reconfigurable logic cores are not fitted to meet these requirements.

It is an object of the invention to provide a method for creating an architecture of a reconfigurable logic core, which architecture can be deployed for various purposes, and the implementation of which is cost-efficient in terms of area, performance and power. This object is achieved by providing a method, characterized by the characterizing portion of claim 1.

The invention relies on the perception that a template can be used to describe such an architecture. The architecture can then easily be created as an instance of the template. The template is a model which defines logic components, routing components and interface components of a reconfigurable logic core. For example, logic components may be logic elements, processing elements, logic blocks, logic tiles and arrays in a hierarchical order. Routing components may comprise routing channels comprising routing tracks which provide interconnection means between the logic components. Interface components may be input and output ports. The model is configured by a number of parameters; the value of these parameters is in accordance with an application domain.

For example, an application domain may comprise data-path oriented functionality, random-logic oriented functionality or memory-oriented functionality. Each application domain requires a certain architecture of the components. E.g. a data-path oriented logic element must have an architecture comprising a certain number of primary input ports, secondary input ports, a carry input port, at least one arithmetic output port, a Boolean output port and a carry output port. The number of these input and output ports are parameters of the template. By choosing appropriate values for all parameters of the template, the architecture which is generated by the template can be fine-tuned for a specific application domain. In that case, the overhead which is caused by e.g. a large number of switches and interconnect wires in a reconfigurable logic core can be reduced significantly, while the reconfigurable logic core is still flexible enough to perform a plurality of functions within the specific application domain.

The concept according to the invention is referred to as template-based domain-specific reconfigurable logic. The main features of this concept are:

a reconfigurable logic architecture which is application-domain-specific rather than general-purpose;

a generic template of a reconfigurable logic architecture from which domain-specific instances can be derived;

a modular design concept, in particular a modular architecture allowing creation of variable-size reconfigurable logic cores using a minimal number of different types of tiles.

In order to guarantee a large application area, traditional FPGAs (and eFPGAs) are made general-purpose, which increases their cost overhead. However, SoCs typically target a specific application domain rather than all possible application domains. Because applications belonging to an application domain or a class of applications share similar characteristics and functions, it is thus possible to optimize a reconfigurable logic architecture for such a domain. In this manner a significant reduction of the cost overhead can be achieved. The template according to the invention has the following other advantages.

The template enables a fast and flexible creation of domain-specific reconfigurable logic cores such as embedded FPGAs.

By using a generic architecture model and allowing an arbitrary change of its parameters, many various architecture instances can be created. This enables a systematic architecture space exploration with experiments on a much larger set of potentially interesting solutions than would be possible to generate using conventional (manual) methods.

The complexity of a VLSI implementation process concerning a large set of different reconfigurable logic cores (template instances) can be considerably reduced if the specification of their architectures, in the form of a netlist or a layout, for example, can be generated automatically from the generic architecture template.

If the parametrizable architecture template is also used to model architectures for the needs of mapping (CAD) tools (e.g. technology mapping, placement, routing), such tools can be made retargetable, which means that they can be deployed on various platforms.

It is remarked that the idea of tuning reconfigurable logic to an application domain as such is known. The benefit of making reconfigurable logic less general-purpose has been recognized in the past, and various application-domain-specific reconfigurable logic architectures have been proposed in academia, mostly for DSP type of applications. Also, the introduction of coarse-grain reconfigurable computing architectures (coarse-grain reconfigurable computing architectures are reconfigurable on the level of words instead of the level of bits as classical FPGAs) has been driven by the idea of the cost reduction in certain application areas. Examples of such architectures include: the RAA architecture of Hewlett-Packard and the XPP processor from PACT. Yet another concept of application-domain-specific reconfigurable computing has been proposed as a part of the Totem project at the University of Washington (‘Totem: Custom Reconfigurable Array Generation’, Compton & Hauck, Proceedings of IEEE Symposium on FPGAs for Custom Computing Machines, April 2001), where a software package enabling an automatic creation of coarse-grain custom reconfigurable logic architectures, by using a predefined architecture template and a set of a priori known algorithms, has been developed. By a considerable reduction in flexibility, the Totem architectures are able to achieve the cost level which is closer to the cost of ASIC's rather than to the cost of FPGA's.

It is also remarked that the concept of a parametrisable reconfigurable logic architecture has been used in the past. In ‘Architecture and CAD for Deep-Submicron FPGAs’, Kluwer Academic Publishers, 1999, Betz et al. use a parametrizable description to model different variants of FPGA architectures for the purpose of a flexible CAD toolset. Such a toolset, which includes a placement and routing tool called VPR (Versatile Placement and Routing) as well as a packing (clustering) tool called T-VPack (Timing-driven Packing for VPR), can be used as a part of the mapping flow targeting any LUT-based FPGA architecture. The architecture model used by Betz introduces some limitations, because of which only relatively simple FPGA structures can be modeled. The details of the Betz's architecture model, with a special emphasis on the automation of the architecture generation process from a high level description, are discussed in the referenced document written by Betz et al.

However, the following aspects make the concept according to the invention significantly different from the concepts already known.

Firstly, unlike application-oriented architectures from academia which have only been optimized towards a single application domain, the concept according to the invention uses a complete approach by taking into account requirements of different application domains. Secondly, the concept according to the invention assumes that similar type of processing kernels may be shared across different application domains. This means that for certain application domains that, based on their similarities, can be classified as an application class, only one type of architecture is required. This is essential since often the support of very many different flavors of reconfigurable logic architectures may be economically unjustified. Thirdly, the invention aims at a much higher level of flexibility than the one offered, for example, by the architectures proposed in the Totem project; the Totem architectures are optimized towards a limited set of well-defined kernels only. On the one hand, this increases the cost penalty, on the other hand, it lowers the risk since the mapped kernels can still be updated or replaced with new ones after a reconfigurable architecture is implemented in silicon.

Also, the Betz's model of a reconfigurable architecture differs significantly from the template of a reconfigurable logic architecture according to the invention. Firstly, the main purpose of the Betz's model is achieving flexibility in the generation of routing architectures for a mapping tool. As a consequence, the information about the logic block in such a model is reduced to very few parameters that are essential for the proper functioning of the tool. In principle, only the routing architecture can be generated, while logic blocks are modeled as black boxes of the specified granularity. In contrast, the template according to the invention defines a complete architecture of a reconfigurable logic device, that is, all functional blocks (logic and input/output blocks) and the associated routing resources. Furthermore, the template according to the invention can be applied both to a mapping CAD flow and a physical design flow (e.g. layout generation). Secondly, the Betz's model targets conventional general-purpose FPGA architectures. It assumes a simple k-input LUT as a basic logic element of such architectures; the LUTs can be clustered together forming a coarser logic block. This is in contrast to the template according to the invention, which is meant for the modeling of application-domain oriented architectures. Thus, the values of the template parameters depend on the target application domain. Besides, basic logic elements in our model can be much more complex than a single k-LUT element as assumed in T-VPack and VPR. Thirdly, the Betz's architecture model is based on four levels of hierarchy, while our architecture template features five levels; the additional level of hierarchy in our model allows an unambiguous description of functionally different reconfigurable logic structures.

A further remark is that not only the above-mentioned differences with respect to already known approaches make the concept according to the invention particularly advantageous. Another important distinctive feature is the combination of the concept of the application-domain-specialization of reconfigurable logic architectures with the concept of their automatic generation (derivation) from a generic architecture template. This combination defines the complete methodology, as will be appreciated by a person skilled in the art.

It is noted that U.S. Pat. No. 6,476,636 discloses an architecture of specific commercial eFPGA (Actel Corporation). The complete device is assembled from tiles, which are strictly defined. The document does not address the problem of asymmetry of the routing architecture.

Finally, it is noted that U.S. Pat. No. 6,301,696 discloses a methodology for creating so-called ‘hardened’ FPGA's. ‘Hardening’ means bypassing on-state switches of the programmed FPGAs with metal connections, which leads to a performance improvement. The silicon area of final FPGA is, however, the same as a classical FPGA. The term ‘template’ is used to describe an uncommitted (un-configured) FPGA device.

An embodiment of the method according to the invention is defined in claim 2. In this embodiment the template comprises an array, the array comprising a plurality of logic tiles, and the number of logic tiles being a first parameter. A further embodiment is defined in claim 3, wherein the aspect ratio of the array is a second parameter.

Claim 4 defines a further embodiment of the template according to the invention. In this embodiment, the template further comprises:

at least one simple input/output tile, the simple input/output tile being coupled to a first logic tile;

at least one input/output tile with routing functionality, the input/output tile with routing functionality being coupled to a second logic tile;

a corner routing tile, the corner routing tile being coupled to at least two input/output tiles.

Claim 5 defines an embodiment of the logic tiles according to the invention. In this embodiment, at least one of the logic tiles comprises:

a logic block, the logic block comprising a plurality of logic block ports;

routing resources, the routing resources comprising:
a plurality of routing tracks;
logic ports, the logic ports being arranged to couple the logic block ports to a neighboring logic tile;
routing ports, the routing ports being arranged to couple the routing tracks to a neighboring logic tile;
direct ports, the directs ports enabling a direct connection of the logic block with neighboring logic tiles.

Claim 6 defines an embodiment of the logic block according the invention. In this embodiment, the logic block comprises:

a plurality of processing clusters, the number of processing cluster being a third parameter, wherein at least one of the processing clusters comprises a plurality of serially connected processing elements, the number of processing elements being a fourth parameter, and the processing cluster further comprising a plurality of first secondary input ports, a first carry input port and a first carry output port;

a first multiplexer block, the first multiplexer block being arranged to be controlled by control signals issued by a first input selection block, the first multiplexer block being arranged to make a selection from first intermediate signals issued by the processing elements;

an output selection block, the output selection block being arranged to receive the selection of the first intermediate signals and to determine the number of output signals of the logic block, the output selection block further being arranged to generate the output signals and to send the output signals to output ports of the logic block;

a flip-flop block, the flip-flop block being arranged to register the output signals.

Claim 7 defines a further embodiment of the logic block according to the invention, wherein the first input selection block is arranged to couple the first primary input ports to second primary input ports, the second primary input ports being comprised in the processing elements, and to select input signals; the first input selection block further being arranged to accept output signals of the logic block as input signals such that a feedback loop is realized.

Claim 8 defines an embodiment of the processing elements according to the invention. In this embodiment, at least one of the processing elements comprises:
a plurality of serially connected logic elements, the number of logic elements being a fifth parameter;

the second primary input ports;

a plurality of second secondary input ports, the second secondary input ports being coupled to third secondary input ports comprised in the logic elements;

a second carry input port, the second carry input port being coupled to a third carry input port comprised in a first one of the serially connected logic elements;

a second carry output port, the second carry output port being coupled to a third carry output port comprised in a last one of the serially connected logic elements;

a plurality of first arithmetic output ports;

a first Boolean output port;

a second input selection block, the second input selection block being arranged to couple the second primary input ports to third primary input ports comprised in the logic elements, and to select input signals;

a second multiplexer block, the second multiplexer block being arranged to be controlled by control signals issued by the second input selection block, the second multiplexer block being arranged to select signals originating from second Boolean output ports comprised in the logic elements, and the second multiplexer block further being arranged to produce an output signal for the first Boolean output port;

wherein second arithmetic output ports comprised in the logic elements are coupled to the first arithmetic output ports.

Claim 9 defines an embodiment of the logic elements according to the invention. In this embodiment, at least one of the logic elements comprises:

a plurality of third primary input ports, the number of third primary input ports being a sixth parameter;

the third carry input port or a further carry input port;

the third carry output port or a further carry output port;

one of the second Boolean output ports;

a plurality of the second arithmetic output ports, the number of second arithmetic output ports being a seventh parameter.

Claim 10 defines a reconfigurable logic core having an architecture created by a method according to the invention. The methods according to the invention are particularly advantageous for creating architectures for such a reconfigurable logic core. These architectures can be generated automatically.

The present invention is described in more detail with reference to the drawings, in which:

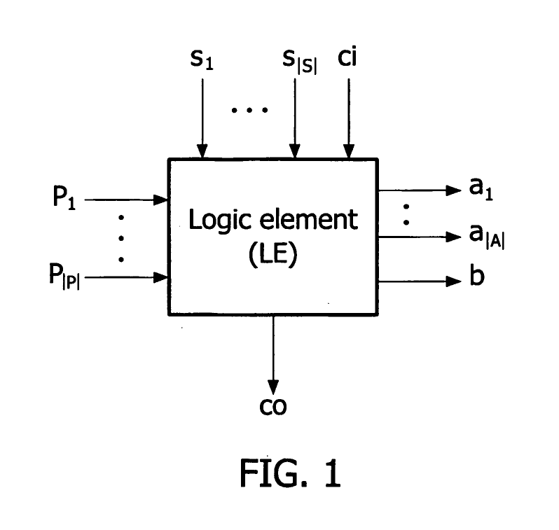

FIG. 1 illustrates a logic element which can be used as a building block of a template according to the invention;

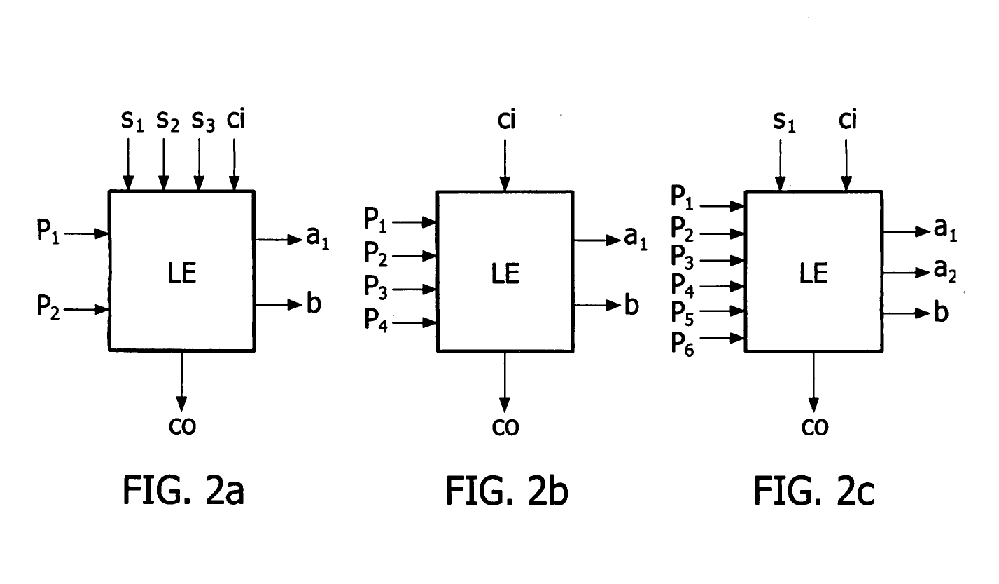

FIG. 2 illustrates examples of domain-specific logic elements;

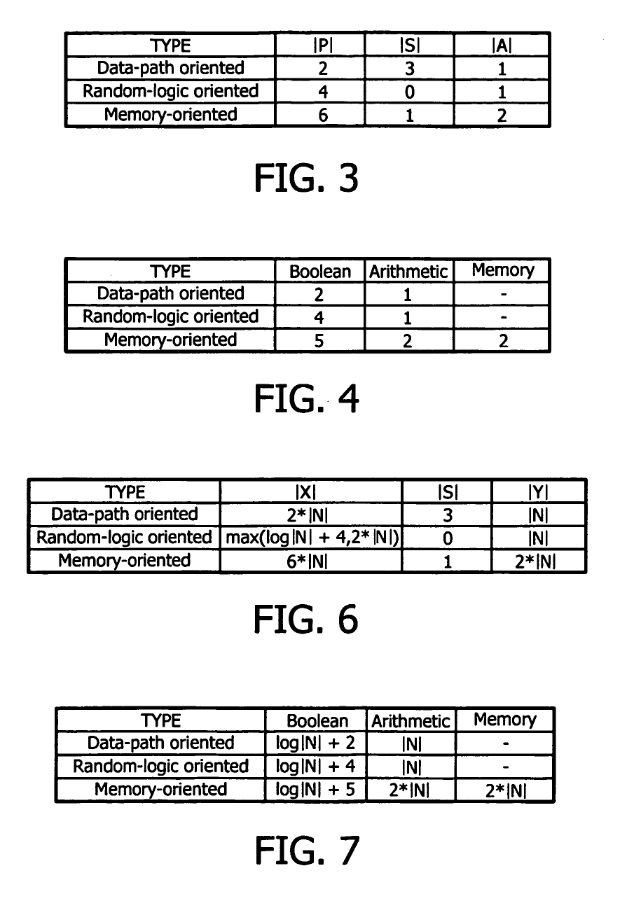

FIG. 3 illustrates the number of ports of the logic elements as illustrated in FIG. 2;

FIG. 4 illustrates the functionality of the logic elements as illustrated in FIG. 2;

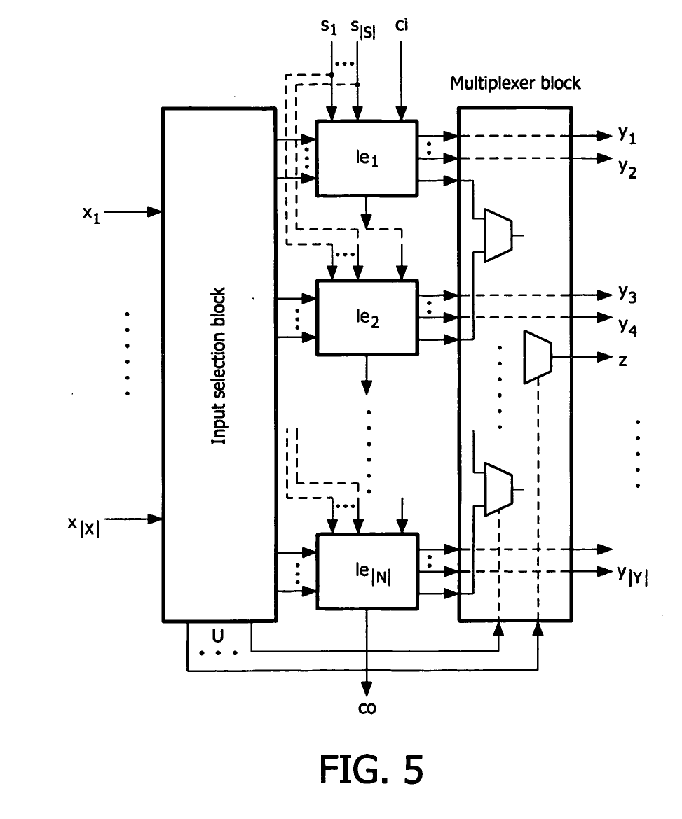

FIG. 5 illustrates a processing element comprising a plurality of logic elements according to the invention;

FIG. 6 illustrates the number of input and output ports of the processing element as illustrated in FIG. 5, dependent on the type of the logic elements used as its basic components;

FIG. 7 describes the functionality of processing elements built of logic elements of various types;

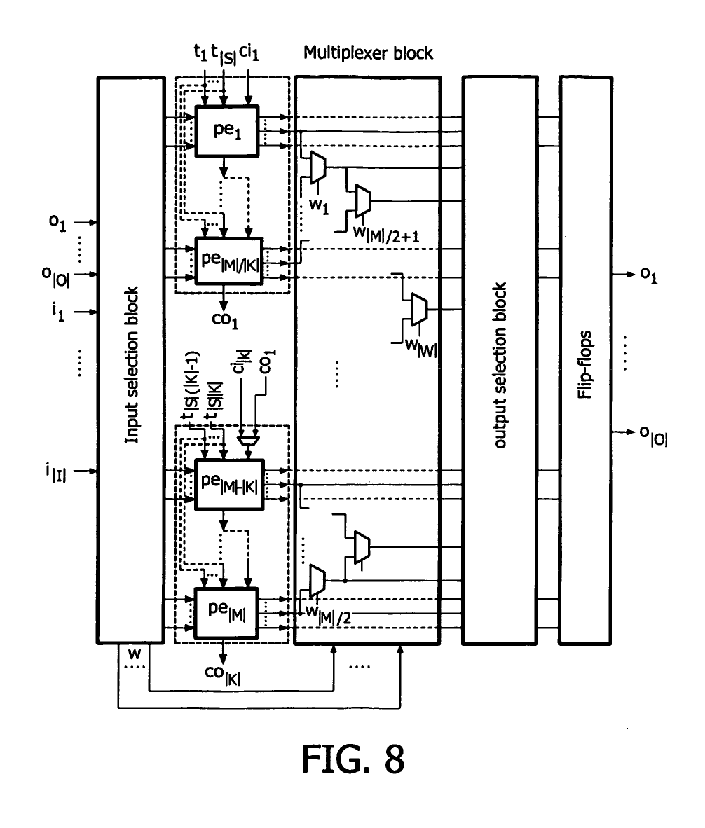

FIG. 8 illustrates a logic block comprising clusters of processing elements according to the invention;

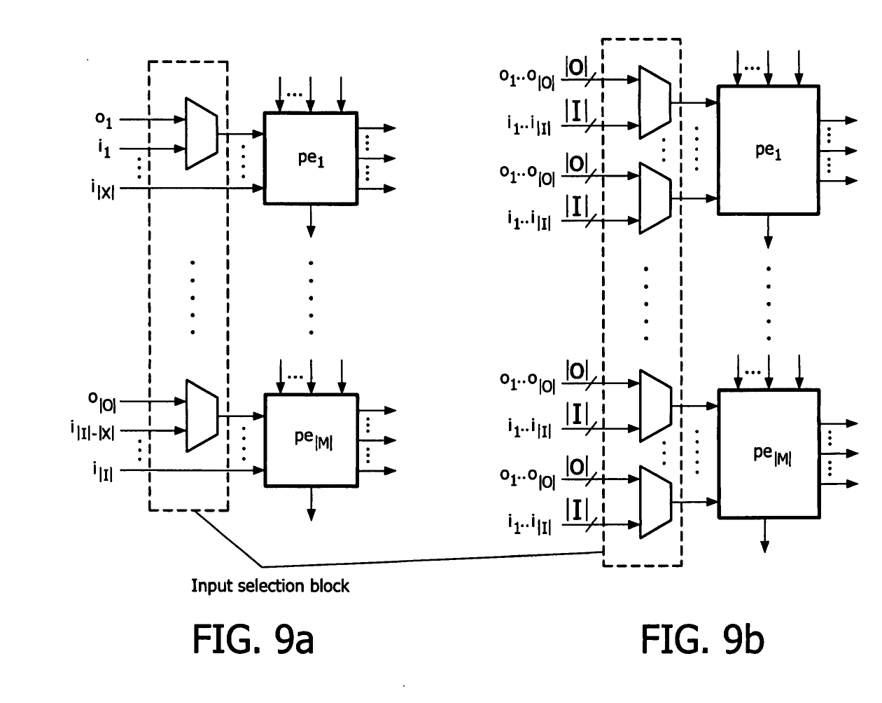

FIG. 9(a) and FIG. 9(b) illustrate input selection blocks with one-to-one feedback connections and full feedback connections;

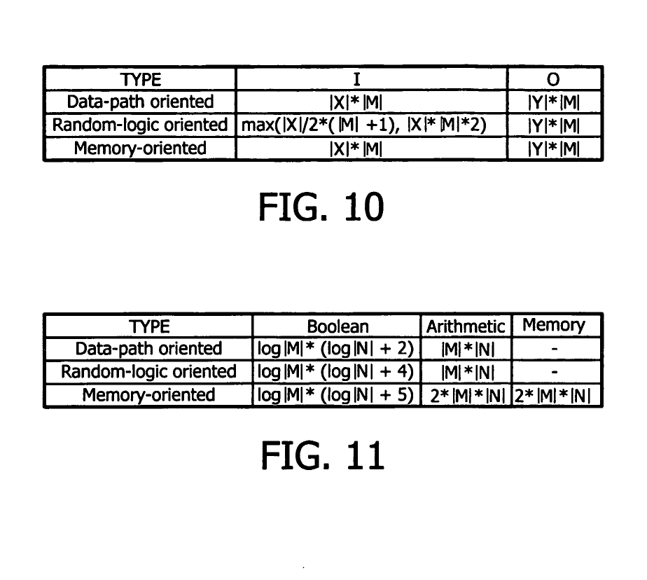

FIG. 10 illustrates the number of the primary input and output ports of the logic block as illustrated in FIG. 8, dependent on the type of the logic element;

FIG. 11 illustrates the granularity of the largest Boolean, arithmetic and memory functions that can be implemented in the logic block as illustrated in FIG. 8, dependent on the type of the logic element;

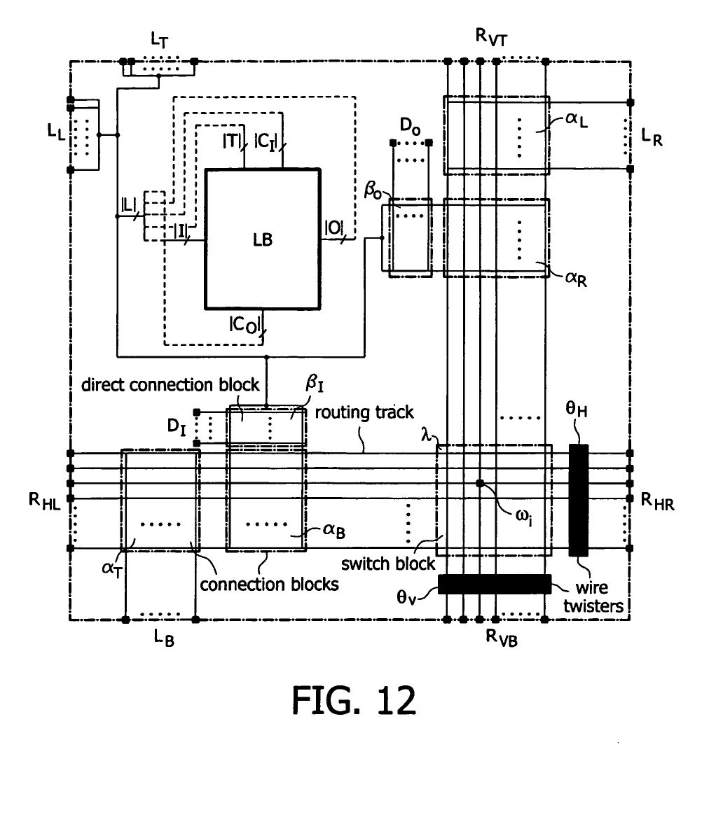

FIG. 12 illustrates a logic tile comprising a logic block according to the invention;

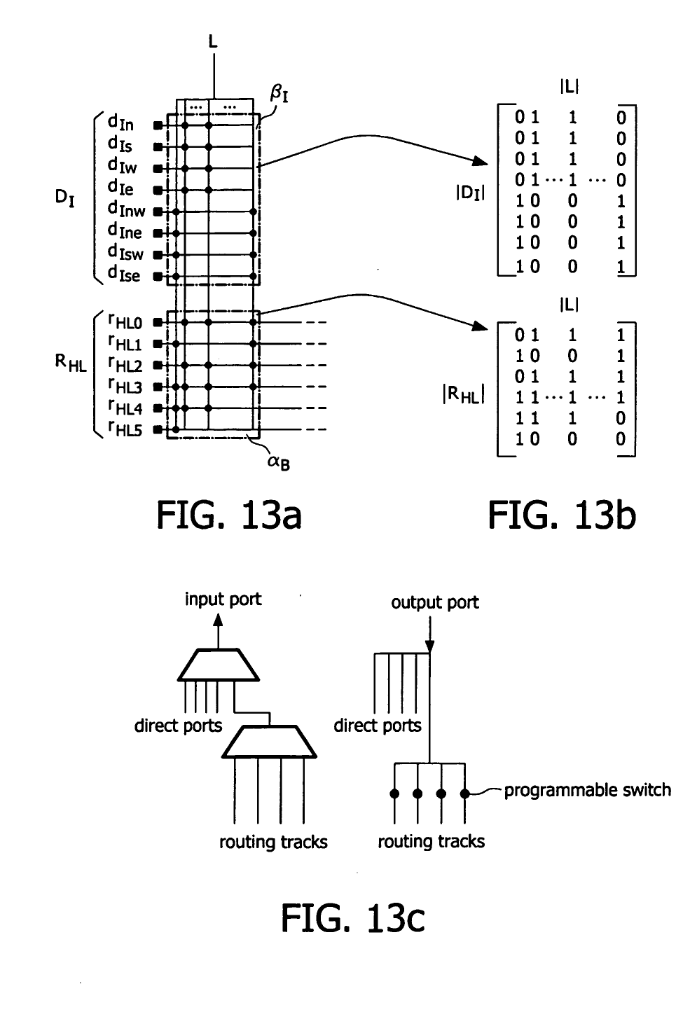

FIG. 13(a) illustrates an example of the connectivity between selected ports of a logic block, direct ports, and routing tracks of a horizontal routing channel;

FIG. 13(b) illustrates the connectivity matrices corresponding to the example as illustrated in FIG. 13(a);

FIG. 13(c) illustrates a possible implementation of the connection blocks;

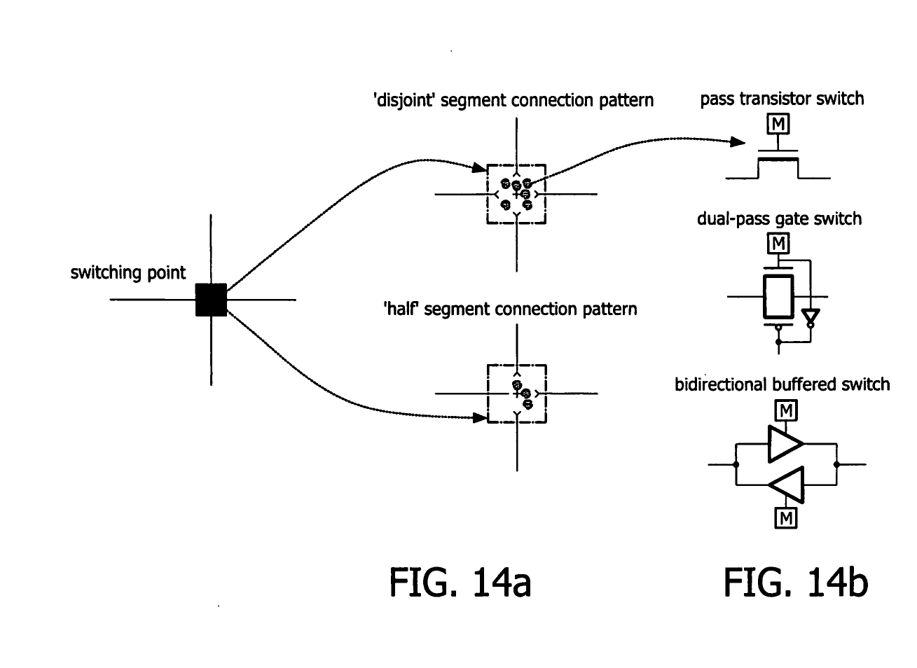

FIG. 14(a) illustrates two different types of segment connection patterns;

FIG. 14(b) illustrates three types of programmable switches;

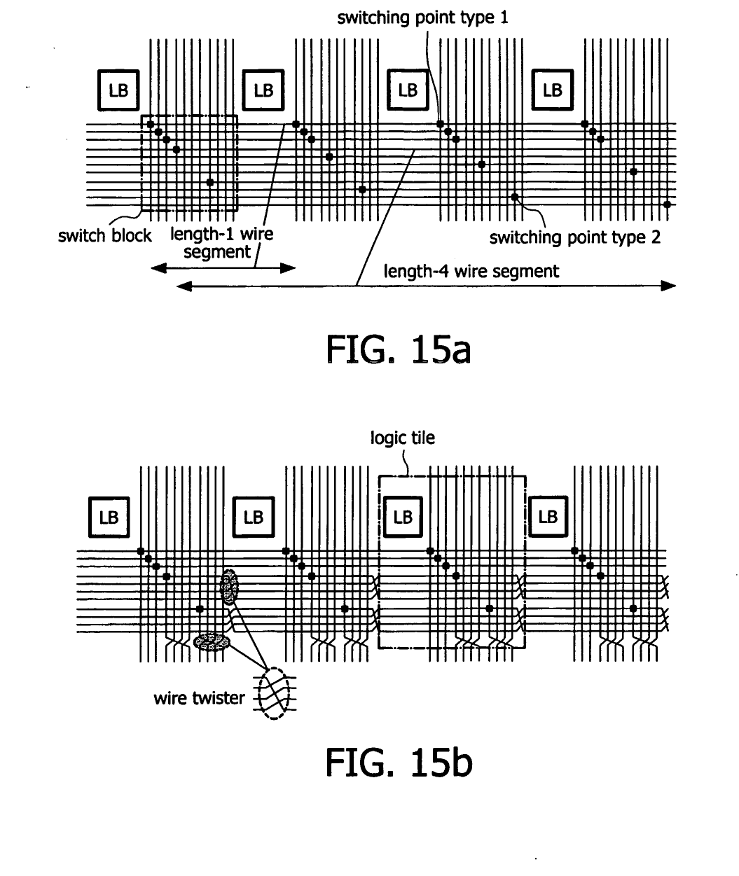

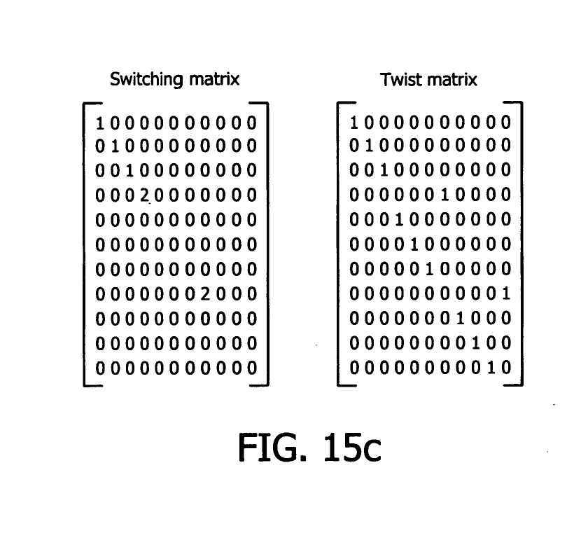

FIG. 15 illustrates an example of a routing architecture with a routing channel consisting of three tracks with length-1 wire segments and eight tracks with length-4 wire segments;

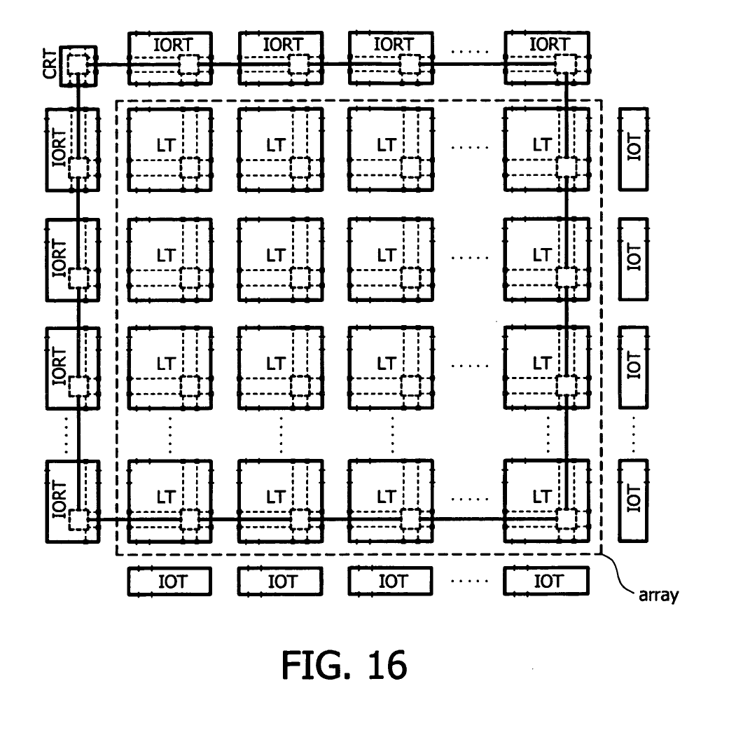

FIG. 16 illustrates an array comprising logic tiles LT according to the invention;

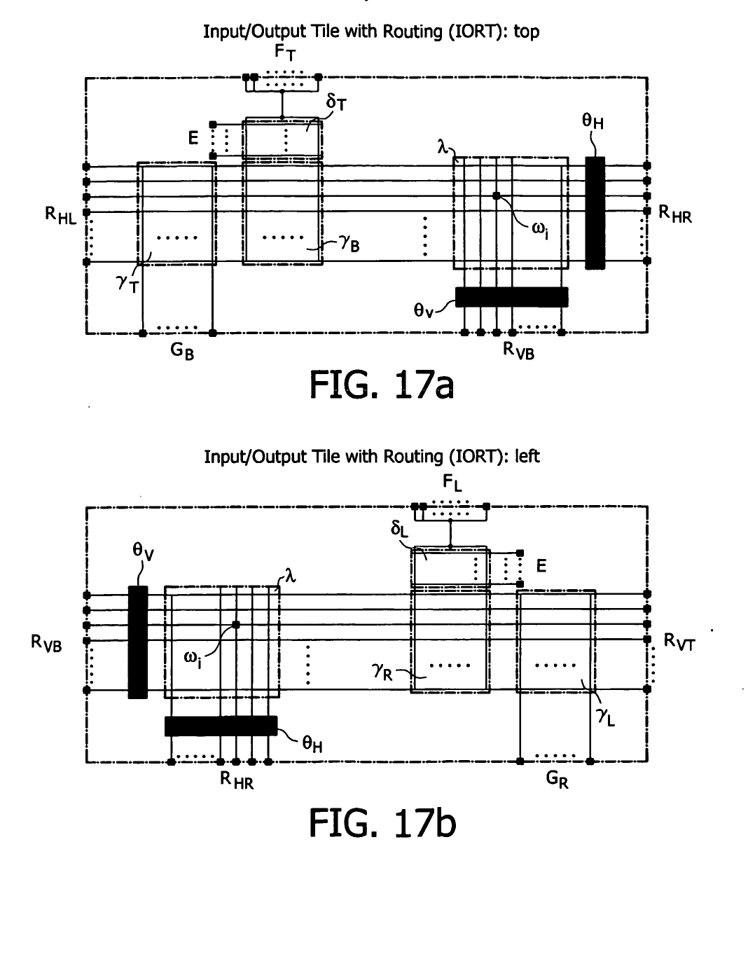

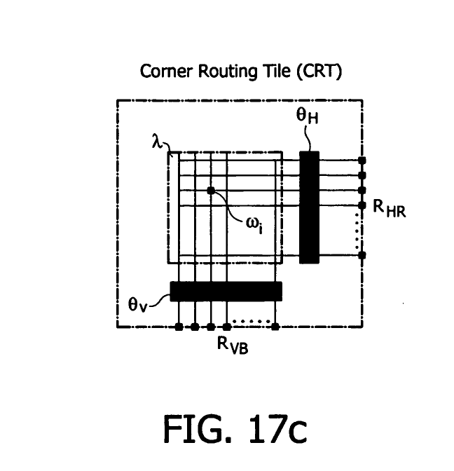

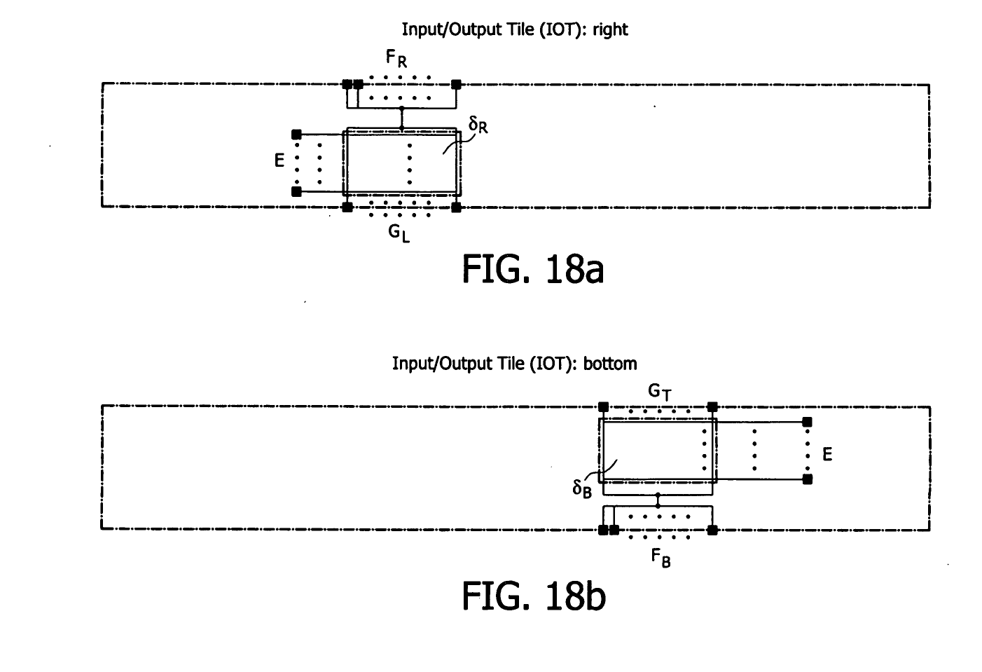

FIG. 17 and FIG. 18 illustrate examples of architectures of auxiliary tiles with routing and of simple auxiliary tiles;

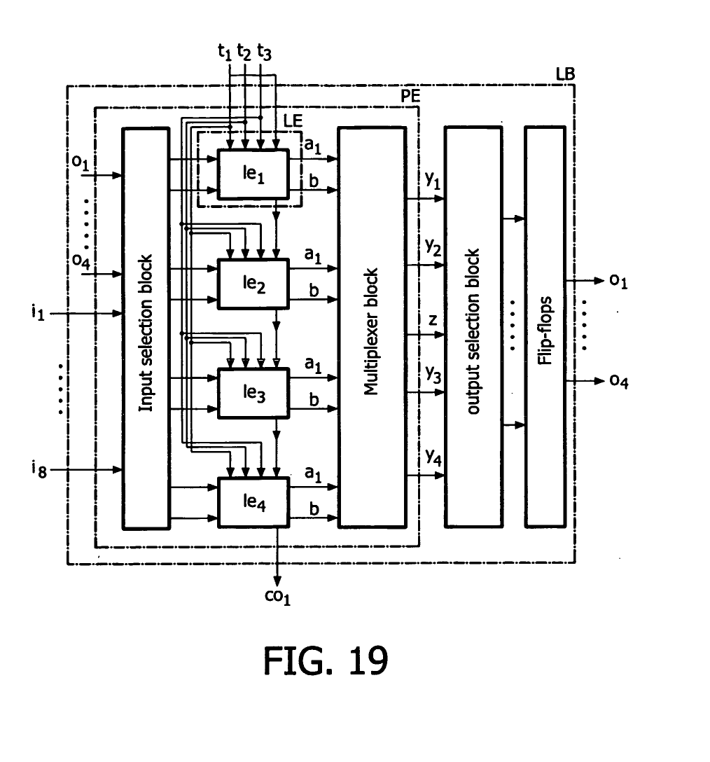

FIG. 19 shows an example of an architecture instance of a data-path oriented FPGA logic block.

The architecture template according to the invention defines a way of generating a complete architecture of any type of application-domain oriented reconfigurable logic core (of a stand-alone or embedded FPGA) using a limited number of basic building blocks called tiles. It is assumed that the generated architecture is homogeneous and hierarchical. In a preferred embodiment of the architecture template which is described below, the levels of hierarchy (in rising order) define the following modules: a logic element, a processing element, a logic block, a logic tile, and an array of a reconfigurable logic core.

FIG. 1 illustrates a logic element LE which can be used as a building block of a template according to the invention. A logic element LE is a basic Look-Up Table based (LUT-based) functional component of a reconfigurable logic architecture. The type TYPE of the logic element depends on the type of application domain (an application class). The logic element LE has the set P=(pᵢ: 0<i≦|P|) of primary input ports, the set S={sᵢ: 0<i≦|S|} of secondary input ports, and a carry input port ci. It also has the set A={aᵢ: 0<i≦|A|} of arithmetic output ports, a Boolean output port b, and a carry output port co. The number of ports of the logic element LE and its functionality depend on the type TYPE of the logic element. The type TYPE depends on the application domain for which the reconfigurable logic core will be used.

Three examples of domain-specific logic elements are shown in FIG. 2.

The number of ports and functionality of the logic elements are given in FIG. 3 and FIG. 4, respectively. The functionality is described as the granularity of basic Boolean, arithmetic and memory functions that can be implemented in the logic element. In that sense, the granularity is defined as the number of bits of an input vector of the maximal Boolean function, the number of bits of a single operand of an arithmetic function, and the number of bits of data input of a memory.

FIG. 5 illustrates a processing element comprising a plurality of logic elements le₁, le₂ up to and including le_{|N|}, according to the invention. The processing element comprises the set N={leᵢ: 0<i≦|N|} of serially connected logic elements. |N| determines the maximal granularity (in terms of the number of bits of the input vector) of a fully specified Boolean function which can be implemented in the processing element. The processing element has the set X={xᵢ: 0<i≦|X|} of primary input ports, the set S={sᵢ: 0<i≦|S|} of secondary input ports, and a carry input port ci. It also has the set Y={yᵢ: 0<i≦|Y|} of output ports, a Boolean output port z, and a carry output port co.

The input ports xᵢ of the processing element are connected via the input selection block to the primary input ports pᵢ of the |N| successive logic elements. The input selection block, which comprises a set of multiplexers, guarantees that, dependent on the functional mode of the processing element, the primary input ports pᵢ of the logic elements always receive the correct set of signals from the primary input ports xᵢ of the processing element. The number |X| of primary input ports of the processing element is equal to the cumulative number of 1-bit inputs of the largest Boolean, arithmetic or memory function (whichever is greater) that can be implemented in the processing element. The |S| secondary input ports sᵢ of the processing element are connected directly to the secondary input ports sᵢ of all logic elements. In contrast, the carry input ports ci and carry output ports co of logic elements are chained together. This means that all logic elements except the first one have their carry input ports ci connected to the carry output port co of the preceding logic element. The first logic element of the processing element, that is le₀, has its carry input port ci connected to the carry input port ci of the processing element; similarly, the last logic element of the processing element, that is le_{|N|} has its carry output port co connected to the carry output port co of the processing element. The arithmetic output ports aᵢ of the logic elements are connected directly with the |Y| output ports yᵢ of the processing element. The Boolean output ports b of the logic elements are multiplexed in the multiplexer block comprising a log|N|-level network of 2:1 multiplexers. The multiplexers are controlled by the set U={uᵢ: 0<i≦|U|} of control signals which are issued by the input selection block. The output of the multiplexer block, which is the output of the final 2:1 multiplexer in this block, connects to the Boolean output z of the processing element.

The number of input and output ports of the processing element, dependent on the type TYPE of the logic elements used as its basic components, is given in FIG. 6. FIG. 7 describes the functionality of the processing elements built of logic elements of various types TYPE.

FIG. 8 illustrates a logic block comprising clusters of processing elements pen, pe₂ up to and including pe|M|, according to the invention. A logic block comprises the set M={peᵢ: 0<i≦|M|} of processing elements, which are organized in |K| parallel clusters of serially connected processing elements. The number of processing elements in a cluster depends for example on the word-size used in certain applications. Each cluster is characterized by an independent set of secondary input ports tᵢ, and independent carry input ports ciᵢ and carry output ports coᵢ. The output signals of the logic block can be registered, which means that they can be synchronized with a clock signal. The output signals can also be fed to the inputs of the logic block allowing the realization of more complex logic functions or functions with feedback loops. It is noted that input pins, such as the secondary input ports tᵢ and the carry input port ciᵢ, can sometimes be shared or merged because they are used exclusively.

The logic block has the set I={iᵢ: 0<i≦|I|} of primary input ports, and |O| feedback ports that are connected to the ports in the output port set O={oᵢ: 0<i≦|O|} of the logic block. The logic block also has the set T={tᵢ: 0<i≦|T|̂|T|=|S|·|K|} of secondary input ports. A first |S| inputs of the set T, that is t₁, . . . , t_{|S|} belong to the first cluster of processing elements, a second |S| inputs of the set T, that is t_{|S|+1}, . . . , t_{2-|S|}, belong to the second cluster of processing elements, etc. The logic block has also |K| carry input ports ciᵢ and |K| carry output ports coᵢ, wherein ‘i’ is the cluster index such that 0<i≦|K|.

The |I| primary inputs and |O| feedback inputs are fed to the input selection block comprising a set of multiplexers. The input selection block of the logic block serves two purposes. Firstly, if the number of primary input ports of the logic block is lower than the number of primary input ports of the processing elements of all clusters, that is if |I|<|M|·|X|, the input selection block implements a full connectivity between primary inputs of the logic block and the primary inputs of the processing elements. The full connectivity guarantees the required level of (routing) flexibility (which is particularly essential for random logic functions) at a reduced implementation cost. This is because the reduced number of input ports of the logic block yields the reduced amount of routing resource hardware. For architectures in which the number of primary input ports |X| of the processing element is determined by the number of bits k of the input vector of the largest Boolean (random logic) function that the processing element can implement (i.e. |X|=k), the following empirical formula can be used to determine the relationship between the number of primary inputs |X| of the processing element and the number of primary inputs |I| of the logic block comprising |M| processing elements: |I|=|X|/2·(|M|+1).

Secondly, the input selection block allows the realization of the feedback if the signals from the set O of the feedback (output) ports of the logic block are selected as the inputs of the processing elements. Dependent on the target application domain, the input selection block of the logic block can be designed with either one-to-one feedback connections or full feedback connections. The one-to-one feedback connections are typical for data-path-dominated architectures, and allow realization of sequential arithmetic modules such as counters, incrementers, and decrementers, in which one of the arguments receives the registered signal from the output. For that reason, the one-to-one feedback connections connect the 101 output ports of the logic block to the |M|·|X| primary input ports of all processing elements, such that the output port oᵢ of the logic block, associated with the i-th bit of the arithmetic output, is connected to the primary input of the processing element that is associated with the i-th bit of the first arithmetic argument.

In contrast, the full feedback connections connect all |O| output ports of the logic block to all |M|·|X| primary input ports of the processing elements. This type of connections is typical for random-logic-oriented architectures, and it allows implementation of complex Boolean functions (then the feedback signals are not registered), or different types of finite state machines (then the feedback signals are registered). The input selection blocks with one-to-one feedback connections and full feedback connections are illustrated in FIG. 9(a) and FIG. 9(b), respectively.

In FIG. 8, the outputs of the input selection block are connected to the primary input ports in the sets X of successive processing elements. The first |S| secondary input ports in the set T of the logic block are connected to the secondary input ports in the set S of all processing elements of the first cluster. In contrast, the i-th carry input port ciᵢ of the logic block is connected via a 2:1 multiplexer to the carry input port ci of only the first processing element of the i-th cluster. The remaining processing elements of that cluster have their carry input ports and carry output ports connected serially. The carry output port co of the last processing element within the i-th cluster is connected to the i-th carry output coᵢ of the logic block. To enable a serial connection of clusters, the 2:1 multiplexer at the carry input port of the first processing element in the i-th cluster (except the first cluster) allows the selection between the signal from the carry input port ciᵢ of the logic block and the signal from the carry output port co of the i-th cluster.

The |S| secondary input ports of the processing elements belonging to the i-th cluster receive signals from the i-th set of secondary input ports of the logic block, that is from ports t_{(i-1)-|S|+1}, . . . , t_{i-|S|}. Furthermore, the carry input port of the first processing element of the i-th cluster receives a signal from the i-th carry input port ciᵢ of the logic block. The remaining processing elements of the i-th cluster have their carry input ports and carry output ports connected serially. The carry output port co of the last processing element within the i-th cluster is connected to the i-th carry output port co; of the logic block.

The multiplexer block of the logic block is a log|M|-stage network of 2:1 multiplexers which are controlled by the control signals from the set W={wᵢ: 0<i≦|W|} originating from the input selection stage. The multiplexers of the first stage select between signals from the Boolean output ports z of successive pairs of processing elements. Each multiplexer of the second stage selects between a pair of signals coming from the outputs of successive multiplexers of the first stage; each multiplexer of the third stage selects between a pair of signals coming from the outputs of successive multiplexers of the second stage, etc. The output signals of multiplexers in all stages are directed to output ports of the multiplexer block. This is in contrast to the multiplexer block of the processing element, in which the output signal of only the final multiplexer (i.e. in the last stage) is directed to an output port of the multiplexer block.

The signals from the output ports of the multiplexer block and signals from the first |Y| output ports of all processing elements are connected to the inputs of the output selection block. The output selection block is a multiplexer network which determines the final number of output signals of the logic block as well as the ports on which these signals appear. It is assumed that all output signals of the multiplexer block and all first |Y| signals of the processing elements can be chosen as logic block outputs. The signals from the output selection block are directed to the flip-flop block. The flip-flop block allows any output of the logic block to be registered. The output signals of the flip-flop block, registered or not, are directed to the |O| output ports of the logic block.

FIG. 10 illustrates the number of the primary input and output ports of the logic block dependent on the type TYPE of the logic element. FIG. 11 illustrates the granularity of the largest Boolean, arithmetic and memory functions that can be implemented in the logic block dependent on the type TYPE of the logic element.

FIG. 12 illustrates a logic tile comprising a logic block LB according to the invention. The logic tile is a main building block of a reconfigurable logic architecture. It comprises a logic block LB and routing resources of the logic block LB. The routing resources define the number of routing tracks in the horizontal and vertical routing channels, their segmentation, and the way how routing tracks connect to the ports (pins) of the logic block. The routing resources also define the types of programmable switches that link the routing wire segments together.

The logic tile has three different types of ports: logic ports L_{L} (left), L_{R} (right), L_{T} (top) and L_{B} (bottom), routing ports R_{HL} (horizontal left), R_{HR} (horizontal right), R_{VT} (vertical top), R_{VB} (vertical bottom), and direct ports D_{I} (inputs) and D_{O} (outputs). The logic ports are used to connect the ports of the logic block to the routing tracks of neighboring tiles; the routing ports are the end terminals of the routing tracks in the logic tile and are used to connect to routing channels of neighboring tiles; the direct ports enable a direct connection to neighboring logic tiles, that is without passing programmable switches.

L in FIG. 12 denotes the set of all logic block ports of the logic block LB, which includes the sets of the primary input ports 1, secondary input ports T, and carry input ports C_{I}, as well as the sets of output ports O and carry output ports C_{O}, that is L=I∪T∪C_{I}∪O∪C_{O}.

The logic block ports in the set L of the logic block LB are connected to the ports in the sets L_{L} and L_{T} of the logic tile. The ports in the set L_{L} connect to the routing tracks of the neighboring logic tile on the left via the ports in the set L_{R} of the left neighboring logic tile; the ports in the set L_{T} connect to the routing tracks of the neighboring logic tile on the top via the ports in the set L_{B} of the top neighboring logic tile. The ports in the set L of the logic block LB also connect to the routing tracks within the logic tile. The connections of the logic block ports in the set L to the routing tracks of the logic tile are realized in so-called connection blocks.

The connectivity in the connection blocks is described using a connectivity matrix. The rows of the connectivity matrix are elements of the routing port sets, while the columns are elements of the logic block port sets. The connectivity matrix is filled with values ‘0’ and ‘1’. The value ‘1’ at the (i,j) position in the matrix means that a connection is present between an i-th routing track and a j-th logic block port, while the value ‘0’ means that no connection is present. The connection blocks of the logic tile and thus their corresponding connectivity matrices, are described by functions α_{T}, α_{B}, α_{L} and α_{R}, such that:

α_{T}: (R_{HL}×L_{B})→{0,1};

α_{B}: (R_{HL}×L)→{0,1};

α_{L}: (R_{VT}×L_{R})→{0,1};

α_{R}: (R_{VT}×L)→{0,1}.

It is noted that these matrices can also be considered to be parameters of the template. The contents of the matrices can be generated automatically using an algorithm.

The connectivity in direct connection blocks, that is between logic block ports and the direct ports of the logic tile, is defined in a similar way. In this case, the rows of the connectivity matrix are addressed by the elements of the direct port set D_{I} or D_{O}, and the columns by the elements of the logic block port set L. The direct connection block for inputs is described by the function β_{I}, while the direct connection block for outputs by the function β_{O}. It is noted that the connectivity matrix of the direct connection block for inputs has its last |O|+|C_{O}| columns filled with values ‘0’ (no connections to the output ports of the logic block), whereas the connectivity matrix of the direct connection block for outputs has its first |I|+|T|+|C_{I}| columns filled with values ‘0’ (no connections to the input ports of the logic block). The connectivity functions β_{I} and β_{O} that describe the filling of connectivity matrices for direct ports are defined as follows:

β_{I}: (D_{I}×L)→{0,1};

βO: (D_{O}×L)→{0,1}.

The input and output ports of the logic block that connect to exactly the same set of routing tracks (via the logic ports of the logic tile) as well as to the same set of direct input and direct output ports of the logic tile, respectively, can be reduced to a single port only. This allows a reduction of the implementation cost of the routing architecture.

In FIG. 13(a) an example of the connectivity between selected ports of the logic block, the direct ports, and the routing tracks of the horizontal routing channel is shown. FIG. 13(b) shows the corresponding connectivity matrices and FIG. 13(c) shows a possible implementation of the connection blocks.

The segmentation (length) of the routing tracks (i.e. the number of logic blocks the routing tracks span before being separated by programmable switches), the switch block architecture (i.e. the way how routing tracks in horizontal and vertical routing channels connect together), and the type of programmable switches are defined by the function λ, such that λ: (R_{HL}×R_{VT})→{0,ωᵢ}. The function λ describes the switching matrix. The rows of the switching matrix are elements from the routing port set R_{HL}, and the columns are the elements from the routing port set R_{VT}. The switching matrix is filled with value ‘0’ or with elements ωᵢ from the set Ω, such that Ω={ωᵢ: ωᵢεN\{0}̂1≦i≦|Ω|} wherein N is the set of natural numbers. The set Ω is the set of the switching point types.

A switching point type is defined by the segment connection pattern and the type of programmable switch used to create the connection between routing track segments. The segment connection pattern defines the way of connecting a routing track segment to the horizontal and vertical track segments that correspond to it. The programmable switch defines an implementation of a single connection between a pair of the routing track segments in the switching point. The size of the set Ω is thus determined by the number of combinations of the segment connection patterns and programmable switch types, and elements ωᵢ of that set are numbered accordingly. For example, for two different types of the segment connection patterns (e.g. ‘disjoint’ and ‘half’ in FIG. 14(a)) and three types of programmable switches (e.g. a pass transistor switch, a dual-pass gate switch, and a bi-directional buffered switch in FIG. 14(b)), six different switching points ω₁, . . . , ω₆ are possible. If two routing tracks that cross have no connection, the value ‘0’ is placed in the corresponding position of the switching matrix.

The horizontal and vertical tracks in the logic tile end with so-called wire twisters. Thanks to the wire twisters, the routing resources of each logic tile can be made identical. Consequently, only one logic tile type suffices to build a reconfigurable logic core, rather than very many different ones. The wire twisters are needed if the routing architecture includes routing segments which span more than one logic block LB (i.e. routing segments with a length greater than ‘length-1’). In that case, segments of equal length which span more than one logic block LB must be twisted (see FIG. 15(b)). Furthermore, the total number of tracks of a given length must always be a multiple of that track length. For example, the acceptable numbers of routing tracks of the length-4 are: 4, 8, 12, 16, etc. Wire twisting in horizontal and vertical routing channels is defined by functions θ_{H} and θ_{V}, respectively, such that:

θ_{H}: (R_{HL}×R_{HR})→{0,1};

θ_{V}: (R_{VT}×R_{VB})→{0,1}.

The functions θ_{H} and θ_{V} define horizontal and vertical twist matrices. The rows of the matrices are elements of the routing ports sets on the left and top of the logic tile, that is R_{HL} and R_{VT}, respectively. The columns of the matrices are elements of the routing ports sets on the right and bottom of the logic tile, that is R_{HR} and R_{VB}, respectively. The matrices are filled with values ‘0’ and ‘1’. The value ‘1’ means that a connection is present between the routing tracks that are associated with those routing ports. The value ‘0’ means that no connection is present. Typically, the horizontal and vertical twist matrices are identical.

FIG. 15 illustrates an example of a routing architecture with a routing channel consisting of three tracks with length-1 wire segments and eight tracks with length-4 wire segments. FIG. 15(a) illustrates the architecture in a conceptual way. It is noted that the length-1 wire segments use connection switches type 1 (e.g. a ‘disjoint’ segment connection pattern and pass-transistor-based switch), whereas the length-4 wire segments use connection switches type 2 (e.g. a ‘disjoint’ segment connection pattern and a buffer-based switch). In FIG. 15(b) an implementation of such an architecture is shown. The wire segments of the length greater than length-1 are twisted according to a modulo-length scheme. Finally, FIG. 15(c) describes a switching matrix of the logic tile, wherein values ‘1’ and ‘2’ refer to the two different types of switching points. The twist matrix (horizontal and vertical) describes the twisting mechanism of the routing tracks in the logic tile.

FIG. 16 illustrates an array comprising logic tiles LT according to the invention. The top level of a reconfigurable logic architecture according to the invention is an array of logic tiles LT. The number of logic tiles LT comprised in the array and the aspect ratio of the array are parameters of the template. The logic tiles LT are surrounded by auxiliary tiles CRT, TORT, IOT which have a twofold function. Firstly, they act an interface between a reconfigurable logic fabric and the other system resources that are embedded on the same piece of silicon. Secondly, they complete the routing architecture. The latter is required because the external routing channel created by the routing resources of the logic tiles LT on the edge of the array is present only at the bottom and right side of the array. Therefore, input/output tiles with routing IORT are placed on the left side and the topside of the array. Simple input/output tiles IOT are placed at the right and bottom side of the array. Additionally, a corner routing tile CRT that closes the external routing channel is placed at the left top corner of the array. The bold ring in FIG. 16 shows a resultant routing channel created in this manner.

The logic tiles LT are abutted via their routing ports. This means that the ports in the horizontal left R_{HL} connect to the ports in the horizontal right set R_{HR} of a neighboring logic tile. Similarly, the ports in the vertical top set R_{VR} connect to the ports in the vertical bottom set R_{VB} of a neighboring logic tile. The connections to the routing tracks of neighboring logic tiles on the left and top are implemented via pairs of ports from the set of ports L_{L}-L_{R} and L_{T}-L_{B}, respectively.

Examples of architectures of auxiliary tiles with routing CRT, IORT and of simple auxiliary tiles IOT are shown in FIG. 17 and FIG. 18. The elements of the auxiliary tiles CRT, IORT, IOT are defined analogously to the definition of elements of the logic tiles LT. The top input/output tile with routing IORT is illustrated in FIG. 17(a); it has two sets of input/output ports F_{T} and G_{B}, and three sets of routing ports, that is R_{HL}, R_{HR} and R_{VB}. The ports in the set F_{T} connect to the system resources, while the ports in the set G_{B} enable the connection of the ports in the set L_{T} of a logic tile LT at the top of the array to the routing resources of the top input/output tile with routing IORT. The routing ports in the sets R_{HL} and R_{HR} connect to the ports in the sets R_{HR} and R_{HL} of neighboring IORT tiles, respectively. The ports in the set R_{VB} connect to the ports in the set R_{VT} of a logic tile LT at the top of the array. The set E is the set of direct input and output ports of the tile and it connects to the direct input and direct output ports in the sets D_{I} and D_{O} of the logic tiles LT, respectively. The connectivity matrices γ_{T}, γ_{B} and δ_{T} in FIG. 17(a) are defined as follows:

γ_{T}: (R_{HL}×G_{B})→{0,1};

γ_{B}: (R_{HL}×F_{T})→{0,1};

δ_{T}: (E×F_{T})→{0,1}.

The left input/output tile with routing IORT depicted in FIG. 17(b) comprises the same elements as the top input/output tile with routing IORT. However, the positions of these elements are mirrored with respect to the positions of elements in the top input/output tile with routing IORT. The left input/output tile with routing IORT has two sets of input/output ports F_{L} and G_{R}, three sets of routing ports, that is R_{VB}, R_{VT} and R_{HR}, and the set of direct ports E. The ports in the set F_{L} connect to the system resources, while the ports in the set G_{R} enable the connection of the ports in the set L_{L} of a logic tile LT on the left edge of the array to the routing resources of the left input/output tile with routing IORT. The routing ports in the sets R_{VB} and R_{VT} connect to the ports in the sets R_{VT} and R_{VB} of neighboring IORT tiles, respectively. The ports in the set R_{HR} connect to the ports in the set R_{HL} of a logic tile LT at the left edge of the array. The connectivity matrices γ_{L}, γ_{R} and δ_{L} in FIG. 17(b) are defined as follows:

γ_{L}: (R_{VT}×G_{R})→{0,1};

γ_{R}: (R_{VT}×F_{L})→{0,1};

δ_{L}: (E×F_{L})→{0,1}.

The corner routing tile CRT depicted in FIG. 17(c) has two sets of routing ports, that is R_{VB} and R_{HR}. The ports in the set R_{VB} connect to the ports in the set R_{VT} of the most top left input/output tile with routing IORT. The ports in the set R_{HR} connect to the ports in the set R_{HL} of the most left top input/output tile with routing IORT.

The right input/output tile IOT depicted in FIG. 18(a) has two sets of input/output ports F_{R} and G_{L}, and the set of direct ports E. The ports in the set F_{R} connect to the system resources, while the ports in the set G_{L} connect to the routing resources of logic tiles LT at the right edge of the array via the set L_{R} of the logic tile ports. The connectivity matrix δ_{R} for direct connections is defined as δ_{R}: (E×F_{R})→{0,1}.

The bottom input/output tile JOT depicted in FIG. 18(b) plays a similar role as the right input/output tile IOT, but it is placed at the bottom of the reconfigurable logic core. The bottom input/output tile IOT has two sets of input/output ports F_{B} and G_{T}, and the set of direct ports E. The ports in the set F_{B} connect to the system resources, while the ports in the set G_{T} connect to the routing resources of logic tiles LT at the bottom edge of the array via the set L_{B} of the logic tile ports. The connectivity matrix δ_{B} for direct connections is defined as δ_{B}: (E×F_{B})→{0,1}.

It is noted that the connectivity matrices λ in each tile are defined identically. The correct functioning of the switch blocks in the logic tiles at the edge of the array and the input/output tiles with routing is guaranteed by the proper programming of the configuration memory of the reconfigurable logic core. This means, for example, that programmable switches of the right bottom logic tile are programmed such that no routing connection to the bottom and to the right of this tile is possible.

FIG. 19 shows an example of an architecture instance of a data-path oriented FPGA logic block. The logic block structure has been derived from the above-described template setting the template parameters as follows:
logic element level: TYPE=data-path, |P|=2, |S|=3, |A|=1;
processing element level: |N|=4, |X|=8, |S|=3, |Y|=4;
logic block level: |M|=1, |K|=1, |I|=8, |O|=4.

The logic block of this type implements both data-path functions (up to 4-bits) and random logic function (up to 4 inputs).

It is remarked that the scope of protection of the invention is not restricted to the embodiments described herein. Neither is the scope of protection of the invention restricted by the reference symbols in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features.

1. A method for creating an architecture of a reconfigurable logic core on an integrated circuit, the architecture comprising logic components, routing components and interface components, characterized in that the architecture is derived from a template, the template being a model configured by a plurality of parameters, wherein the model defines the logic components, the routing components and the interface components, the parameters having values and the values being in accordance with an application domain.

2. A method as claimed in claim 1, wherein the template comprises an array, the array comprising a plurality of logic tiles, and the number of logic tiles being a first parameter.

3. A method as claimed in claim 2, the aspect ratio of the array being a second parameter.

4. A method as claimed in claim 3, wherein the template further comprises:
at least one simple input/output tile, the simple input/output tile being coupled to a first logic tile;
at least one input/output tile with routing functionality, the input/output tile with routing functionality being coupled to a second logic tile;
a corner routing tile, the corner routing tile being coupled to at least two input/output tiles.

5. A method as claimed in claim 4, wherein at least one of the logic tiles comprises:
a logic block, the logic block comprising a plurality of logic block ports;
routing resources, the routing resources comprising:
a plurality of routing tracks;
logic ports, the logic ports being arranged to couple the logic block ports to a neighboring logic tile;
routing ports, the routing ports being arranged to couple the routing tracks to a neighboring logic tile;
direct ports, the directs ports enabling a direct connection of the logic block with neighboring logic tiles.

6. A method as claimed in claim 5, wherein the logic block ports comprise first primary input ports and the logic block further comprises:
a plurality of processing clusters, the number of processing cluster being a third parameter, wherein at least one of the processing clusters comprises a plurality of serially connected processing elements, the number of processing elements being a fourth parameter, and the processing cluster further comprising a plurality of first secondary input ports, a first carry input port and a first carry output port;
a first multiplexer block, the first multiplexer block being arranged to be controlled by control signals issued by a first input selection block, the first multiplexer block being arranged to make a selection from first intermediate signals issued by the processing elements;
an output selection block, the output selection block being arranged to receive the selection of the first intermediate signals and to determine the number of output signals of the logic block, the output selection block further being arranged to generate the output signals and to send the output signals to output ports of the logic block;
a flip-flop block, the flip-flop block being arranged to register the output signals.

7. A method as claimed in claim 6, wherein the first input selection block is arranged to couple the first primary input ports to second primary input ports, the second primary input ports being comprised in the processing elements, and to select input signals; the first input selection block further being arranged to accept output signals of the logic block as input signals such that a feedback loop is realized.

8. A method as claimed in claim 6, wherein at least one of the processing elements comprises:
a plurality of serially connected logic elements, the number of logic elements being a fifth parameter;
the second primary input ports;
a plurality of second secondary input ports, the second secondary input ports being coupled to third secondary input ports comprised in the logic elements;
a second carry input port, the second carry input port being coupled to a third carry input port comprised in a first one of the serially connected logic elements;
a second carry output port, the second carry output port being coupled to a third carry output port comprised in a last one of the serially connected logic elements;
a plurality of first arithmetic output ports;
a first Boolean output port;
a second input selection block, the second input selection block being arranged to couple the second primary input ports to third primary input ports comprised in the logic elements, and to select input signals;
a second multiplexer block, the second multiplexer block being arranged to be controlled by control signals issued by the second input selection block, the second multiplexer block being arranged to select signals originating from second Boolean output ports comprised in the logic elements, and the second multiplexer block further being arranged to produce an output signal for the first Boolean output port;
wherein second arithmetic output ports comprised in the logic elements are coupled to the first arithmetic output ports.

9. A method as claimed in claim 8, wherein at least one of the logic elements comprises:
a plurality of third primary input ports, the number of third primary input ports being a sixth parameter;
the third carry input port or a further carry input port;
the third carry output port or a further carry output port;
one of the second Boolean output ports;
a plurality of the second arithmetic output ports, the number of second arithmetic output ports being a seventh parameter.

10. A reconfigurable logic core having an architecture created by a method as claimed in claim 1.
